(19) United States
(12) Patent Application Publication
(10) Pub. No.: US 2019/0364503 A1
(43) Pub. Date: Nov. 28, 2019

(54) POWER-SAVE MODE FOR WIRELESS DEVICE

(71) Applicant: Nokia Technologies Oy, Espoo (FI)

(72) Inventors: Mika Ilkka Tapani KASSLIN, Espoo (FI); Henrik Enrico RANTALA, Berkeley, CA (US); Janne MARIN, Espoo (FI); Olli Petteri ALANEN, Espoo (FI)

(21) Appl. No.: 16/469,762

(22) PCT Filed: Dec. 16, 2016
(86) PCT No.: PCT/US2016/067241

§ 371 Date: Jun. 14, 2019

(51) Int. Cl. H04W 52/02

(52) U.S. Cl. CPC H04W 52/0229; H04W 84/12; H04W 52/0235

(57) ABSTRACT

This document discloses a solution for operating a wireless device power-efficiently. According to an aspect, there is provided a method comprising: performing, by the wireless device by using a first radio interface of the wireless device, an association to an access node of a wireless network; indicating, by the wireless device to the associated access node, transition to a dormant mode and entering the dormant mode where the first radio interface is disabled; receiving, by the wireless device in the dormant mode, a wake-up frame from the access node through a second radio interface of the wireless device; upon receiving the wake-up frame, maintaining the dormant mode towards the access node but temporarily enabling, by the wireless device, the first radio interface to receive at least one frame from the access node; and receiving said at least one frame by the wireless device through the first radio interface and, upon receiving said at least one frame, disabling the first radio interface in the dormant mode.

### FIELD

The invention relates to the field of wireless communications and, particularly, to improving power savings in a wireless device.

### BACKGROUND

Wireless networks employ various power-saving features to reduce power consumption in battery-operated devices such as mobile devices. Networks based on IEEE 802.11 (Wi-Fi) specifications have introduced a power-save mode where a device may temporarily shut down its Wi-Fi interface to reduce the power consumption. Many other networks employ similar power-save modes that allow a battery-operated device to “doze” between frame transmissions or when there is no data to deliver. In the dozing state, the Wi-Fi or another main radio interface of the battery-operated device may be temporarily shut down. The dozing may have to be cancelled from time to time, e.g. for receiving information from the wireless network. The information may be provided in a beacon signal or another periodic broadcast signal, for example. There may be other reasons that cancel the dozing and cause the device to activate its main radio interface for a frame transmission/reception.

Maintaining the main radio interface in the doze state for extended durations would be advantageous from the perspective of the power consumption.

### BRIEF DESCRIPTION

According to an aspect, there is provided the subject matter of the independent claims.

Embodiments of the invention are defined in dependent claims.

### LIST OF DRAWINGS

Embodiments of the present invention are described below, by way of example only, with reference to the accompanying drawings, in which

FIG. 1 illustrates an example of a wireless communication scenario to which embodiments of the invention may be applied;

FIG. 2 illustrates a flow diagram of an embodiment for operating a dormant mode in a wireless device;

FIG. 3 illustrates a flow diagram of an embodiment for communicating, by an access node, with a wireless device in a dormant mode;

FIG. 4 illustrates operational modes and transitions between the operational modes according to an embodiment of the invention;

FIG. 5 illustrates a state transition diagram within a dormant mode of a wireless device;

FIGS. 6 and 7 illustrate signalling diagrams of embodiments for carrying out frame transmissions between an access node and a wireless device operating in a dormant mode; and

FIGS. 8 and 9 illustrate block diagrams of apparatuses according to some embodiments of the invention.

### DESCRIPTION OF EMBODIMENTS

The following embodiments are examples. Although the specification may refer to “an”, “one”, or “some” embodiment(s) in several locations, this does not necessarily mean that each such reference is referring to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

A general wireless communication scenario to which embodiments of the invention may be applied is illustrated in FIG. 1. FIG. 1 illustrates wireless communication devices comprising an access point (AP) 100 and a plurality of wireless terminal devices (STA) 110, 112. The access point may be associated with a basic service set (BSS) which is a basic building block of an IEEE 802.11-based wireless local area network (WLAN). The most common BSS type is an infrastructure BSS that includes a single AP together with all STAs associated with the AP. The AP may be a fixed AP or it may be a mobile AP. The AP 100 may also provide access to other networks, e.g. the Internet. In another embodiment, the BSS may comprise a plurality of APs to form an extended service set (ESS). In yet another embodiment, a terminal device 110 may establish and manage a peer-to-peer wireless network to which one or more other terminal devices 112 may associate. In such a case, the peer-to-peer wireless network may be established between two or more terminal devices and, in some embodiment, the terminal device managing the network may operate as an access node providing the other terminal device(s) with a connection to other networks, e.g. the Internet. In other embodiments, such routing functionality is not employed and the connection terminates in the terminal devices. Such a peer-to-peer network may be utilized for data sharing or gaming, for example.

The access node 100 may be connected to a network management system (NMS) 130 which may comprise an apparatus configured to maintain channel usage information of wireless networks of one or more access nodes and to configure the channel usage of the wireless networks. For example, it may arrange wireless networks located close to each other to operate on different channels and, thus, avoid interference between the networks. An example scenario is that access nodes of an enterprise are all controlled by the same NMS 130. In an embodiment, the network management system 130 is comprised in one of the access nodes, e.g. in the access node 100. In another embodiment, the network management system is realized by an apparatus different from the access nodes, e.g. by a server computer to which the access nodes may connect via a wired or wireless connection.

While embodiments of the invention are described in the context of the above-described topologies of IEEE 802.11 specifications, it should be appreciated that these or other embodiments of the invention may be applicable to networks based on other specifications, e.g. other versions of the IEEE 802.11, WiMAX (Worldwide Interoperability for Microwave Access), UMTS LTE (Long-term Evolution for Universal Mobile Telecommunication System), LTE-Advanced, a fifth generation cellular communication system (5G), and other networks having cognitive radio features, e.g. transmission medium sensing features and adaptiveness to coexist with radio access networks based on different specifications and/or standards. Some embodiments may be applicable to networks having features defined in the IEEE 802.19.1 specification. One example of a suitable communications system is the 5G system, as mentioned above.

With respect to the definition of the wireless network in the context of the present description, the wireless network may comprise a single BSS or a plurality of BSSs. According to a viewpoint, the wireless network may comprise a plurality of BSSs that have the same service set identifier (SSID) the same roaming identifier, and/or the same roaming partnership.

A terminal device 110, 112 may establish a connection with any one of access nodes it has detected to provide a wireless connection within the neighbourhood of the terminal device. The connection establishment may include authentication in which an identity of the terminal device is established in the access node. The authentication may comprise exchanging an encryption key used in the BSS. After the authentication, the access node and the terminal device may carry out association in which the terminal device is fully registered in the BSS, e.g. by providing the terminal device with an association identifier (AID). It should be noted that in other systems terms authentication and association are not necessarily used and, therefore, the association of the terminal device to an access node should be understood broadly as establishing a connection between the terminal device and the access node such that the terminal device is in a connected state with respect to the access node and waiting for downlink frame transmissions from the access node and its own buffers for uplink frame transmissions.

The terminal devices 100, 112 may discover the access node 100 through a network discovery process. IEEE 802.11ai task group defines principles for fast initial link setup (FILS). One aspect of the principles is to enable faster and more precise AP and network discovery. Some principles may relate to passive scanning in which a scanning device, e.g. a STA, passively scans channels for any beacon, management, or advertisement frames. Other principles may relate to active scanning in which the scanning device actively transmits a scanning request message, e.g. a probe request message or a generic advertisement service (GAS) request, in order to query for present APs or networks. The probe request may also set some conditions that a responding device should fulfil in order to respond to the probe request. In some embodiments, the scanning device may be called a requesting device or a requesting apparatus. Responding devices may transmit scanning response messages, e.g. probe response messages, in response to the scanning request message, wherein the scanning response message may contain information on the responding device, its network, and other networks. Embodiments of the scanning enhancements described herein encompass the network discovery signalling, probe request-response processes, as well as GAS request-response processes.

Power consumption has always been an issue with all wireless networks and mobile communication. 802.11 specifications provide power-save mechanisms like a power save (PS) mode to save power when the STA is associated to an access node. By default, an associated STA is in active mode which enforces it to stay in an awake state when the STA is fully powered and able to transmit and receive frames with the access node. An associated STA may transition to the PS mode with explicit signalling and, while operating in the PS mode, it may save power by operating occasionally in a doze state. In the doze state, the STA is not able to transmit or receive frames but, on the other hand, power consumption of the STA is on a considerably lower level than in the awake state. The STA may wake up from the doze state to receive periodic beacon frames from the access node. While the STA is in the doze state, the access node buffers frames addressed to the STA. The access node transmits buffered multicast/groupcast frames after specific delivery traffic indication map (DTIM) beacon frames, when the STA is awake. Unicast frames may be transmitted only upon the STA in the PS mode has indicated that it has entered into the awake state. The access node indicates with the beacon frames (in a traffic indication map, TIM, field) whether it has frames buffered to the STA.

There are two main mechanisms for the STA in the PS mode to indicate transition to the awake state and to retrieve buffered frames from the access node. The mechanisms are use of PS-Poll frames and use of automatic power save delivery (APSD) and, specifically, unscheduled APSD (U-APSD). In the former, the STA transmits a PS-Poll frame to indicate to the access node that the STA shall be in the awake state until it has received one downlink frame. Once the access node has transmitted a frame to the STA from which it received the PS-Poll frame, the access node assumes that the STA is back in the doze state and continues buffering frames to the STA. When the STA uses the U-APSD scheme, the STA may retrieve multiple frames buffered in the access node by triggering a service period (SP) with an uplink trigger frame transmitted to the access node. Upon transmitting the trigger frame, the STA remains in the awake state until it has received from the access node a frame indicating an end of the service period (EOSP). The EOSP may be indicated by setting an EOSP bit set to a determined value in the frame.

Recent developments in 802.11 work groups have involved introduction of a new low-power radio interface called a wake-up radio (WUR). The WUR has been discussed in a WUR study group. A new task group, TGba, has been established and it will continue the work of the study group. One purpose of the new radio interface is to enable further power-savings by allowing a main radio (also known as a primary connectivity radio) interface used for data communication according to 802.11 specifications to doze for longer periods. The low-power radio interface is called in the study group a wake-up radio (WUR) receiver or a low-power WUR (LP-WUR) receiver, and it is considered to be a companion radio to the primary connectivity radio. A wireless device such as the STA may comprise both a WUR interface and the main 802.11 interface. An access node may comprise a wake-up transmitter and the main 802.11 interface. Accordingly, a device of the wireless network may include a wake-up radio interface and the main interface. It has been proposed that the purpose of the wake-up radio interface is only or mainly to wake-up the main radio interface when the access node has data to transmit to a dozing STA.

The wake-up radio interface may be designed such that it consumes less power than the main radio interface. The wake-up radio interface may employ a simpler modulation scheme than the main radio interface, e.g. the wake-up radio interface may use only on-off keying while the main radio interface uses variable modulations schemes such as phase-shift keying and (quadrature) amplitude modulation. The wake-up radio interface may operate on a smaller bandwidth than the smallest operational bandwidth of the main radio interface, e.g. 5 Megahertz (MHz) for the wake-up radio and 20 MHz for the smallest bandwidth of the main radio interface.

Since the main purpose of the wake-up radio interface is to wake up the main radio interface, the wake-up radio interface may be powered on when the main radio interface is powered off. A wake-up radio interface of the STA may be configured to receive and extract wake-up radio frames transmitted by a wake-up radio interface of the access node. The wake-up radio interface of the STA may be capable of decoding the wake-up radio frames on its own without any help from the main radio interface. Accordingly, the wake-up radio interface may comprise, in addition to a radio frequency front-end receiver components, digital baseband receiver components and a frame extraction processor capable of decoding contents of a wake-up radio frame. The wake-up radio frame may comprise a destination address field indicating a STA that should wake up the main radio interface, and the frame extraction processor may perform decoding of the destination address from a received wake-up radio frame and determine whether or not the destination address is an address of the STA of the frame extraction processor. If yes, it may output a wake-up signal causing the main radio interface to wake up for radio communication with an access node.

The above-described use of the wake-up radio to wake up the main radio interface may be performed when the STA is associated to the access node.

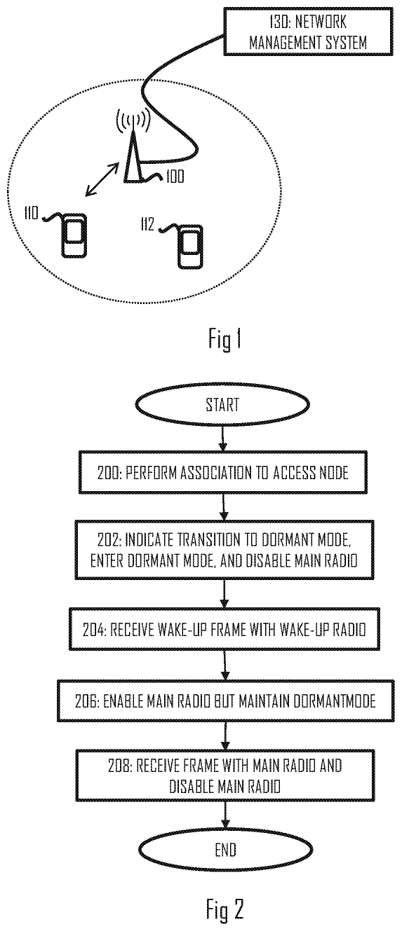

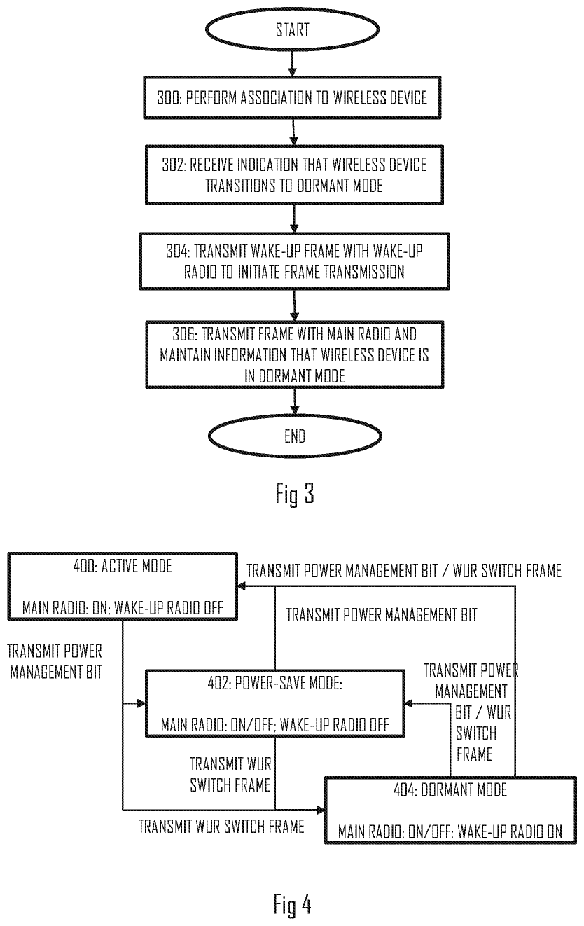

Detailed implementation of the use of the wake-up receiver and state synchronization between the access node and the STA is still under development in the work groups. FIGS. 2 and 3 illustrate a solution for operating a dormant mode in an apparatus having two radio interfaces according to some embodiments of the invention. FIG. 2 illustrates a process for a wireless device such as the STA 110, 112, while FIG. 3 illustrates a process for an access node 100. Referring to FIG. 2, the process comprises as performed by the wireless device: performing (block 200), by using a first radio interface of the wireless device, an association to an access node of a wireless network; indicating (block 202), to the associated access node, transition to a dormant mode and entering the dormant mode where the first radio interface is disabled; receiving (block 204), in the dormant mode, a wake-up frame from the access node through a second radio interface of the wireless device; upon receiving the wake-up frame, maintaining (block 206) the dormant mode towards the access node but temporarily enabling by the wireless device the first radio interface to receive at least one frame from the access node; and receiving (block 208) said at least one frame by the wireless device through the first radio interface and, upon receiving said at least one frame, disabling the first radio interface in the dormant mode.

Referring to FIG. 3, the process comprises as performed by the access node: performing (block 300), by using a first radio interface of the access node, an association to a wireless device; receiving (block 302), from the associated wireless device, an indication that the wireless device shall transition to a dormant mode where wireless device cannot be contacted by the access node by using the first radio interface; determining (block 304) to transmit at least one frame to the wireless device and, upon said determining, using a second interface of the access node to transmit a wake-up frame to the wireless device; after transmitting said wake-up frame, maintaining (block 306) information that the wireless device is in the dormant mode and transmitting the at least one frame to the wireless device through the first radio interface.

Embodiments of FIGS. 2 and 3 describe a process where the wireless device may, in the dormant mode, power-up its main radio interface temporarily to receive one or more frames without changing its mode. After the frame reception, the wireless device may resume the hibernation of the main radio device without any signalling to/from the access node. This reduces signalling overhead and allows efficient dozing in the wireless device. Also, the wireless device and the access node remain synchronized with respect to the mode of the wireless device because the mode remains the same for the duration of the frame transmission/reception.

In an embodiment, payload data from an application layer is transferred only through the main radio interfaces. The wake-up radio interface may be used for waking up the main radio interface and, in some embodiments for transfer of control or management information of the wireless network below the application layer. Let us now describe the operational modes of the wireless device with reference to FIG. 4. As described above, both the wireless device and the access node associated to the wireless device may maintain up-to-date information on the current operational mode of the wireless device. Both the wireless device and the access node may also comprise at least two radio interfaces having different communication configurations: a main radio interface (the first radio interface described above) and a wake-up radio interface (the second radio interface described above). As described above, the wake-up radio interface may employ a transmission configuration that allow lower power consumption than with the main radio interface.

Referring to FIG. 4, in an active mode 400 the wireless device may maintain its main radio interface powered constantly. On the other hand, the wake-up radio interface may be shut down while the main radio interface is powered. Therefore, the wireless device employs only the main radio interface in the active mode 400. When the wireless device is in the active mode 400, the access node may use only the main radio interface in all signalling with the wireless device. In an embodiment, the active mode 400 complies with an active mode specified in IEEE 802.11 specifications.

In a power-save mode 402, the wireless device may control the main radio interface to shut-down occasionally and in a controlled manner. The wake up radio interface may be shut down in the power-save mode 402. Accordingly, the access node and the wireless device may communicate only with the main radio interface in the power-save mode. The wireless device may, for example, power the main radio interface periodically to receive periodic beacon frames from the access node. As described above, the beacon frames may carry the TIM indicating whether or not the access node has buffered downlink data for the wireless device. If the TIM indicates that there is downlink data to be transmitted to the wireless device, the wireless device may transmit a trigger frame to the access node to trigger the transmission of the downlink data. The trigger frame may trigger a service period in which multiple downlink frames may be transmitted. The service period is ended by the access node by explicit signalling, e.g. a subfield in a downlink frame. Thereafter, the wireless device may shut down the main radio interface. In the 802.11 specifications, another mechanism is use of a power-save poll (PS Poll) frame which is an uplink frame transmitted by the wireless device (STA) and indicating to the access node that the wireless device is now awake and ready for receiving a downlink frame. After receiving the frame, the wireless device may shut down the main radio interface or transmit another power-save poll frame.

When the wireless device is a member of a groupcast/multicast group, the wireless device may keep the main radio interface powered right after the reception of the periodic beacon such that a following groupcast/multicast frame may also be received. The access node may transmit the multicast/groupcast frames right after the beacon frames to enable devices in the power-save mode 402 to receive the multicast/groupcast frames. In a similar manner, broadcast frames may be transmitted right after the beacon frames.

In an embodiment, the power-save mode 402 is the power-save mode of IEEE 802.11 specifications.

In the dormant mode 404, the main radio interface may be shut down while the wake-up radio interface is powered on. In the dormant mode, the access node may contact the wireless device with the wake-up radio interface. In the dormant mode 404, the wireless device may keep the main radio interface shut down for extensive time intervals, e.g. for a duration longer than a beacon transmission interval of the access node. The access node may further assume that the wireless device will not check the periodic beacon frames and, thus, gains no information on downlink frames, addressed to the wireless device, buffered in the access node. As a consequence, upon buffering a downlink frame addressed to the wireless device in the dormant mode 404, the access node may transmit a wake-up frame, via the wake-up radio interface, to the wireless device. Receiving the wake-up frame through the wake-up radio interface may trigger the wireless device to power up its main radio interface for frame transmission/reception.

In an embodiment, the wake-up receiver is powered on in all the operational modes 400, 402, 404.

Since the communication between the access node and the wireless device depends on the operational mode of the wireless device, the access node and the wireless device may exchange information on mode transitions of the wireless device. Let us now consider how the mode transitions may be signalled.

The wireless device may indicate transition between the modes 400, 402 by using a sub-field called a power management bit in a frame transmitted by the wireless device to the access node. One value of the power management bit indicates that the wireless device enters the active mode 400 while another value power management bit indicates that the wireless device enters the power-save mode 402. This transition and explicit signalling of the mode transition may follow the IEEE 802.11 specifications.

In a similar manner, the transition between the modes 402, 404 or between the modes 400, 404 may be indicated by the wireless device to the access node by using explicit signaling. The signaling may comprise an information element in a wake-up radio (WUR) switch frame. The WUR switch frame may be specified, for example, by using an action frame format of IEEE 802.11 specifications and defining a new frame or a new frame pair for the purpose of switching to/from the dormant mode 404. Alternatively, a new control type for an existing frame may be specified either by allocating a new sub-type value for the mode change signaling related to the mode 404. Yet another alternative is defining a new frame within an existing control frame extension space of IEEE 802.11 control frames. Table 1 below illustrates an embodiment of contents of the WUR switch frame:

TABLE 1

| Frame | | BSSID | | | |
|---|---|---|---|---|---|
| control | ID | (RA) | TA | Mode | FCS |
| 2 octets | 2 octets | 6 octets | 6 octets | 1 octet | 4 octets |

The frame control field may specify the type and, optionally, a sub-type of the frame, e.g. the WUR switch frame. The ID field comprises an association identifier for the association between the wireless device and the access node. The BSSID (RA) field may comprise a receiver address for the frame indicating the BSS and the access node. The TA field comprises an address of the wireless device. The Mode field may indicate the following: one value indicates entering the dormant mode 404 and another value indicates entering a power management mode, wherein the power management mode may be the power-save mode 402 or the active mode 400. The Mode field may have separate values indicating whether entering the active mode 400 or entering the power-save mode 402. However, this may not be needed, since it may be enough if Mode field indicates exit from dormant mode, since the above-described power management bit in the Frame Control field may still be used to indicate whether entering the active mode 400 or the power save mode 402. To sum up FIG. 4, when the wireless device in the dormant mode 404 wishes to enter the active mode 400 from the dormant mode 404, the wireless device may use the same procedure as when transitioning from the power-save mode 402 to the active mode 400 (the power management bit). However, in another embodiment, the wireless device indicates the mode transition from the dormant mode to the active mode in the WUR switch frame and with a value of the Mode field. Also when switching from the dormant mode 404 to the power-save mode 402, the wireless device may use the power management bit and/or the Mode field of the WUR switch frame to indicate the mode transition. Analogously, when transitioning from the active mode 400 directly to the dormant mode 404, the wireless device may use the same procedure as when transitioning from the power-save mode 402 to the dormant mode 404 (the WUR switch frame). A frame check sequence (FCS) may be used for error detection.

The dormant mode 404 may be available only for connections between devices that both support the dormant mode and have the wake-up radio interface. In the case of a wireless device associated to an access node, the wireless device may be provided with capabilities of the access node through scanning and association. An access node may indicate its capabilities in beacon, probe response and association response frames, for example. Support for dormant mode and WUR capabilities may be indicated with means of one or more fields in such frames. The access node may be provided with capabilities of the wireless device through the association procedure. The wireless device may indicate its capabilities with means of one or more fields in an association request frame it transmits to the access node when initiation the association procedure.

In an embodiment, the wireless device enters the dormant mode 404 immediately after completing association to the access node.

Let us now consider the operation of the wireless device in the dormant mode with reference to FIG. 5. As described above in connection with FIGS. 2 and 3, the wireless device may, in the dormant mode 404, temporarily activate the main radio interface for reception of one or more frames. After completing the reception, the wireless device may shut-down the main radio interface without any explicit signaling with the access node. The access node may also assume that, if the wireless device needs to be contacted by the access node, the next contact shall be with the wake-up radio interface as long as the wireless device stays in the dormant mode. Accordingly, both the wireless device and the access node may maintain the operational mode of the wireless device as the dormant mode during state transitions illustrated in FIG. 5.

Referring to FIG. 5, the dormant mode may have at least two states: an active state 500 where the main radio interface of the wireless device is powered, and a doze state 502 where the main radio interface is shut down. The wake-up radio interface of the wireless device may be powered in the doze state and shut down in the active state 500. In an embodiment, the wake-up radio interface is powered on in both states 502, 500.

Let us now consider the state transitions between the active state 500 and the doze state 502. As described, above, reception of the wake-up frame addressed to the wireless device and received by the wireless device from the access node may trigger the state transition from the doze state 502 to the active state. As a result, the wireless device may power the main radio interface on and, optionally, shut down the wake-up radio interface.

Another criterion for state transition from the doze state 502 to the active state may be timer-based. Upon entering the doze state 502, the wireless device may activate a timer. Upon the timer has counted a determined time interval, the wireless device may trigger the state transition to the active state 500. Upon entering the active state 500, the wireless device may trigger transmission of an uplink control, data or management frame such as a PS poll frame or a trigger frame, or to carry out reception and decoding of at least one beacon frame, for example.

Yet another criterion for state transition from the doze state 502 to the active state may be event-based. For example, the wireless device may determine a need to transmit an uplink control, data or management frame such as the PS poll frame or the trigger frame.

Transition from the active state 500 to the doze state 502 may be triggered by successful reception of one or more downlink frames. When the access node has provided the wireless device with a service period comprising one or more downlink frame transmission, the access node may indicate an end of the service period with a subfield “end of service period” in the last downlink frame of the service period. Upon receiving the last downlink frame successfully and detecting the end of service period, the wireless device may switch to the doze state after transmitting an acknowledgment to the last downlink frame. Upon receiving the acknowledgment, the access node may assume that the wireless device has entered the doze state and can be contacted only with the wake-up radio interface. Accordingly, the indication of the end of the service period by the access node and associated acknowledgment by the wireless device may serve as an implicit indication that the wireless device shall transition to the doze state. Accordingly, no explicit indication is necessary, which provides a reduced signaling overhead.

When the wireless device has triggered transmission of a single downlink frame, e.g. as a result of transmitting the PS poll frame, the state transition from the active state 500 to the doze state may be triggered by the successful reception of the single downlink frame in the active state 500. Upon receiving the acknowledgment to the single downlink frame, the access node may assume that the wireless device has entered the doze state and can be contacted only with the wake-up radio interface.

In an embodiment, the wireless device switches from the active state 500 of the dormant mode to the doze state 502 of the dormant mode with no explicit indication of the switching to the access node.

In an embodiment, the wireless device switches from the active state 500 of the dormant mode to the doze state 502 of the dormant mode with no explicit command from the access node to switch to the doze state, e.g. with no specific command frame from the access node.

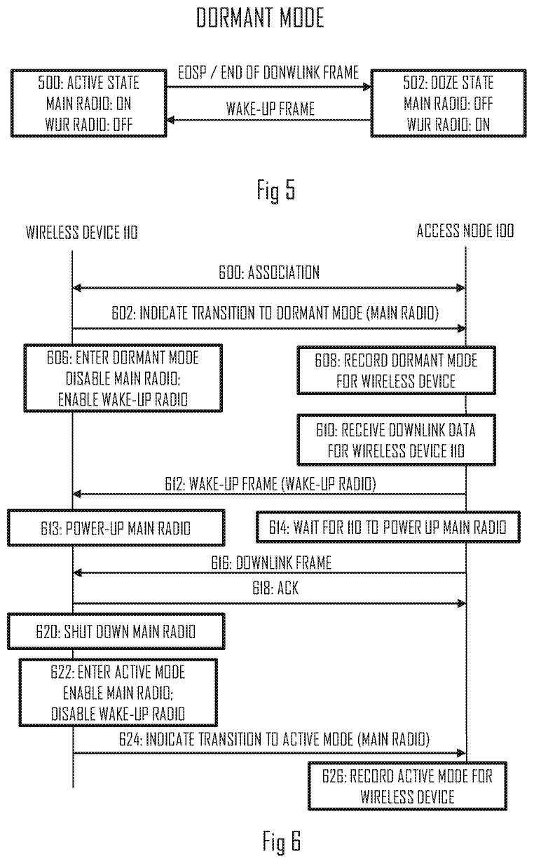

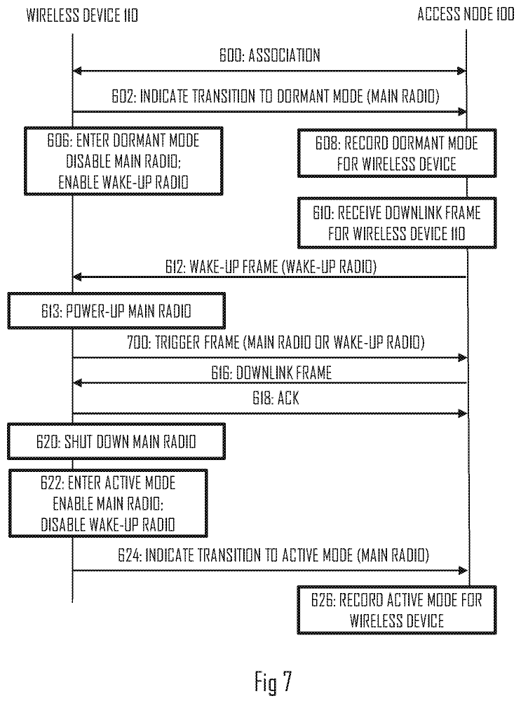

Let us now describe some embodiments of the operation in the dormant mode of the wireless device with reference to FIGS. 6 and 7. FIG. 6 illustrates a signaling diagram illustrating communication between the access node (e.g. the access node 100) and the wireless device (e.g. the STA 110). Referring to FIG. 6, the wireless device and the access node carry out the association and related connection establishment procedures in step 600. By default, the wireless device 110 may be in the active mode 400 after the association. In step 602, the wireless device determines to switch to the dormant mode 404 and indicates the transition to the dormant mode by transmitting the WUR switch frame or another indication with the main radio interface in step 602. Upon receiving the indication in step 602, the access node may record the dormant mode as the operational mode of the wireless device (block 608). Upon transmitting the indication and, optionally, receiving an acknowledgment to the transmission of step 602, the wireless device may enter the dormant mode 404 in block 606 by disabling the main radio interface and powering up the wake-up radio interface.

In block 610, the access node receives downlink data addressed to the wireless device 110. Reception of the downlink data may trigger checking the current operational mode of the wireless device 110. Upon determining that the current mode of the wireless device is the dormant mode 404, the access node may use its wake-up radio interface to transmit a wake-up frame to the wireless device in step 612. Alternatively, the access node may wait until certain amount of downlink data is available in the access node to the wireless device 110 in the dormant mode 404 before transmitting a wake-up frame to the wireless device in step 612. The wake-up frame may comprise a preamble that may comply with 802.11 preamble specifications. The wake-up frame may comprise a payload portion. The 802.11 preamble enables legacy devices to detect the frame as well. The payload portion may comprise a wake-up radio preamble which may be a pseudo-noise (PN) sequence, a medium access control header comprising an address of the wireless device 110 as a receiver address, other optional information, and a frame check sequence. As described above, the wake-up frame may be transmitted and received by using the wake-up radio interface, and it may precede an actual 802.11 frame, or just 802.11 preamble, transmission/reception with the main radio interface.

The wake-up frame may comprise a destination address field comprising an address of the wireless device that is requested to wake up the main radio interface. In another embodiment, the destination address field may comprise a group address or a multicast address requesting a group of wireless devices to wake up their main radio interfaces. In yet another embodiment, the destination address field may be omitted or it may comprise a broadcast address to request for any receiver of the wireless network receiving the wake-up frame to wake up the main radio interface.

Upon receiving the wake-up frame with the wake-up radio interface and optionally detecting that the wake-up frame is addressed to the wireless device 110, the wireless device 110 may power up its main radio interface in block 613. In this embodiment, upon transmitting the wake-up frame the access node 100 may activate a timer counting a determined time interval (block 614). Upon expiry of the timer, the access node may trigger transmission of a downlink frame to the wireless device (step 616). The time interval may be sufficient for the wireless device 110 to decode the wake-up frame and power up the main radio interface. Accordingly, the access node transmits in this embodiment the downlink frame without receiving any indication that the main radio interface of the wireless device is operational. Upon receiving the downlink frame in step 616 and successfully decoding the downlink frame, the wireless device may acknowledge successful reception of the frame in step 618 and enter the doze state 502 by shutting down its main radio interface (block 620) and activating the wake-up radio interface. Upon receiving the acknowledgment in step 618, the access node may resume with the assumption that the wireless device has returned to the doze state 502.

Upon determining to switch from the dormant mode to the active mode, the wireless device may power up the main radio interface (block 622) and transmit to the access node an uplink frame indicating the mode transition to the active mode (step 624). Upon receiving the indication, the access node may store in the record the active mode 400 as the current operational mode of the wireless device (block 626).

In summary, the wireless device may operate in the dormant mode for the duration of steps/blocks 606 and 610 to 620, and the access node may store the dormant mode as the operational mode of the wireless device for the duration of steps/blocks 608 to 618 until receiving the indication in step 624.

FIG. 7 illustrates another embodiment where the steps/blocks denoted by the same reference numbers as in FIG. 6 represent the same or substantially similar functions. In this embodiment, upon transmitting the wake-up frame in step 612 the access node stands by to receive an uplink frame from the wireless device before transmitting the downlink frame in step 616. Upon receiving the wake-up frame in step 612, the wireless device powers up its main radio interface in block 613 and, upon powering up the main radio interface, generates and transmits an uplink frame in step 700 the access node is waiting for. The uplink frame may be a trigger frame or a PS poll frame, for example. Upon receiving the uplink frame in step 700, the access node may generate and transmit the downlink frame in step 616 by using the main radio interface.

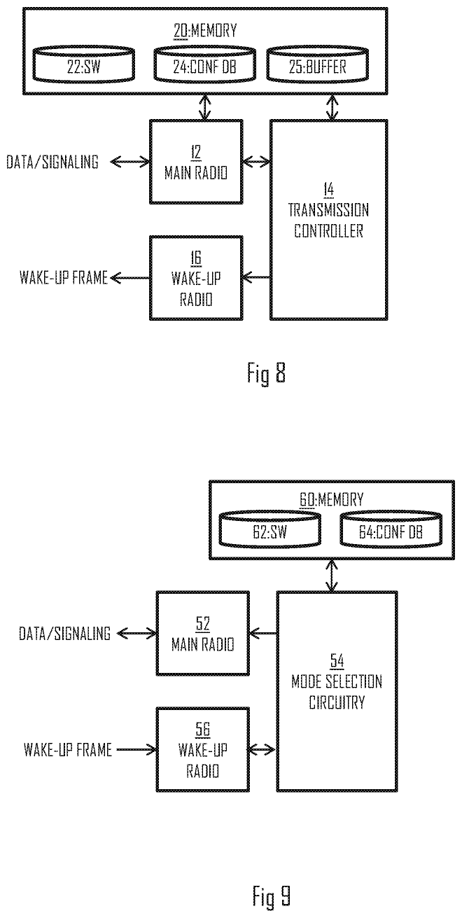

FIG. 8 illustrates an embodiment of a structure of the above-mentioned functionalities of the apparatus executing the process of FIG. 3 or any one of the embodiments performed by the access node 100. The apparatus may be the access node 100. The apparatus may comply with specifications of an IEEE 802.11 network and/or another wireless network. The apparatus may be defined as a cognitive radio apparatus capable of adapting its operation to a changing radio environment, e.g. to changes in parameters of another system on the same frequency band. The apparatus may be or may be comprised in a computer (PC), a laptop, a tablet computer, a cellular phone, a palm computer, or any other apparatus provided with radio communication capability. In another embodiment, the apparatus carrying out the above-described functionalities is comprised in such a device, e.g. the apparatus may comprise a circuitry, e.g. a chip, a chipset, a processor, a micro controller, or a combination of such circuitries in any one of the above-described devices. The apparatus may be an electronic device comprising electronic circuitries for realizing the embodiments of the present invention.

Referring to FIG. 8, the apparatus may comprise the above-described main radio interface 12 configured to provide the apparatus with capability for bidirectional communication with wireless devices in a wireless network managed by the apparatus. The main radio interface 12 may operate according to 802.11 specifications, for example. The main radio interface 12 may comprise analogue radio communication components and digital baseband processing components for processing transmission and reception signals. The main radio interface 12 may support multiple modulation formats.

The apparatus may further comprise the above-described wake-up radio interface 16 comprising a transmission circuitry for generating and transmitting the wake-up frames. The wake-up radio interface 16 may be configured for transmission only but, in some embodiments, the wake-up radio interface may enable uplink communications where the wake-up radio interface 16 has reception capability. The wake-up radio interface 16 may comprise analogue radio communication components and digital baseband processing components for processing transmission and reception signals. The wake-up radio interface 16 may support a single modulation scheme only, e.g. the on-off keying.

The main radio interface and the wake-up radio interface may comprise radio interface components providing the apparatus with radio communication capability within one or more wireless networks. The radio interface components may comprise standard well-known components such as an amplifier, filter, frequency-converter, (de)modulator, and encoder/decoder circuitries and one or more antennas.

The apparatus may further comprise a memory 20 storing one or more computer program products 22 configuring the operation of at least one processor of the apparatus, e.g. a transmission controller 14 described below. The memory 20 may further store a configuration database 24 storing operational configurations of the apparatus. The configuration database may, for example, store the record of the current operational modes of wireless devices associated to the apparatus. The memory 20 may further store the buffer storing downlink data addressed to the wireless devices associated to the apparatus.

The apparatus may further comprise a transmission controller 14 configured to control the operation of the main radio interface 12 and the wake-up radio interface 16. The transmission controller may selectively use the main radio interface 12 and/or the wake-up radio interface 16 to communicate with the wireless devices associated to the apparatus, e.g. on the basis of the current operational mode of the wireless devices. The transmission controller may, for example, control the operation of the access node in the embodiments of FIGS. 3, 6, and 7.

Upon detecting downlink data in the buffer 25 as addressed to a wireless device operating in the dormant mode and in the doze state, the transmission controller 14 may cause the wake up radio interface 16 to generate and transmit the wake-up frame to the wireless device. Upon waiting for a determined time interval or upon receiving an uplink frame from the wireless device through the main radio interface 12, the transmission controller 14 may configure the main radio interface to transmit one or more downlink frames to the wireless device. After transmitting the last downlink frame, the transmission controller may assume that the wireless device can no longer be reached over the main radio interface 12 and, unless receiving any indication from the wireless device, the next contact to the wireless device is again with the wake-up radio interface 16.

In an embodiment, the apparatus comprises at least one processor and at least one memory 20 including a computer program code 22, wherein the at least one memory and the computer program code are configured, with the at least one processor, to cause the apparatus to carry out the functionalities of the access node according to any one of the embodiments of FIGS. 3, 6, and 7. According to an aspect, when the at least one processor executes the computer program code, the computer program code causes the apparatus to carry out the functionalities according to any one of the embodiments of FIGS. 3, 6, and 7. According to another embodiment, the apparatus comprises the at least one processor and at least one memory 20 including a computer program code 22, wherein the at least one processor and the computer program code 22 perform the at least some of the functionalities of the access node according to any one of the embodiments of FIGS. 3, 6, and 7. Accordingly, the at least one processor, the memory, and the computer program code form processing means for carrying out embodiments of the present invention in the access node. According to yet another embodiment, the apparatus carrying out the embodiments of the invention in the access node comprises a circuitry including at least one processor and at least one memory 20 including computer program code 22. When activated, the circuitry causes the apparatus to perform the at least some of the functionalities of the access node according to any one of the embodiments of FIGS. 3, 6, and 7.

FIG. 9 illustrates an embodiment of a structure of the above-mentioned functionalities of the apparatus executing the process of FIG. 2 or any one of the embodiments performed by the wireless device 110. The apparatus may be the wireless device 110. The apparatus may comply with specifications of an IEEE 802.11 network and/or another wireless network. The apparatus may be defined as a cognitive radio apparatus capable of adapting its operation to a changing radio environment, e.g. to changes in parameters of another system on the same frequency band. The apparatus may be or may be comprised in a computer (PC), a laptop, a tablet computer, a cellular phone, a palm computer, or any other apparatus provided with radio communication capability. In another embodiment, the apparatus carrying out the above-described functionalities is comprised in such a device, e.g. the apparatus may comprise a circuitry, e.g. a chip, a chipset, a processor, a micro controller, or a combination of such circuitries in any one of the above-described devices. The apparatus may be an electronic device comprising electronic circuitries for realizing the embodiments of the present invention.

Referring to FIG. 9, the apparatus may comprise the above-described main radio interface 52 configured to provide the apparatus with capability for bidirectional communication with an access node operating a wireless network. The main radio interface 12 may operate according to 802.11 specifications, for example. The main radio interface 12 may comprise analogue radio communication components and digital baseband processing components for processing transmission and reception signals. The main radio interface 12 may support multiple modulation formats.

The apparatus may further comprise the above-described wake-up radio interface 56 comprising a reception circuitry for receiving the wake-up frames. The wake-up radio interface 56 may be configured for reception only but, in some embodiments, the wake-up radio interface may enable uplink communications where the wake-up radio interface 56 has transmission capability. The wake-up radio interface 56 may comprise analogue radio communication components and digital baseband processing components for processing transmission and reception signals. The wake-up radio interface 16 may support a single modulation scheme only, e.g. the on-off keying.

The main radio interface and the wake-up radio interface may comprise radio interface components providing the apparatus with radio communication capability within one or more wireless networks. The radio interface components may comprise standard well-known components such as an amplifier, filter, frequency-converter, (de)modulator, and encoder/decoder circuitries and one or more antennas.

The apparatus may further comprise a memory 60 storing one or more computer program products 62 configuring the operation of at least one processor of the apparatus, e.g. a mode selection circuitry 54 described below. The memory 60 may further store a configuration database 64 storing operational configurations of the apparatus. The configuration database may, for example, store the current operational mode of the apparatus.

The apparatus may further comprise a mode selection circuitry 54 configured to switch the main radio interface 52 and the wake-up radio interface on and off according to the current operational mode of the apparatus. The mode selection circuitry may control the switching according to the state transitions, as described above in connection with FIG. 4. The mode selection circuitry 54 may further control the switching according to the state transitions within the dormant mode, as described above in connection with FIG. 5. For example, upon receiving the wake-up frame in the doze state of the dormant mode through the wake-up radio interface 56, the mode selection circuitry 54 may power-up the main radio interface.

The mode selection circuitry may further control the main radio interface to signal the mode transitions to the associated access node, as described above in connection with FIG. 4. The state transitions within the dormant mode may, however, be carried out without any signalling with the access node.

In an embodiment, the apparatus comprises at least one processor and at least one memory 60 including a computer program code 62, wherein the at least one memory and the computer program code are configured, with the at least one processor, to cause the apparatus to carry out the functionalities of the wireless device according to any one of the embodiments of FIGS. 2 to 7. According to an aspect, when the at least one processor executes the computer program code, the computer program code causes the apparatus to carry out the functionalities according to any one of the embodiments of FIGS. 2 to 7. According to another embodiment, the apparatus comprises the at least one processor and at least one memory 20 including a computer program code 22, wherein the at least one processor and the computer program code 22 perform the at least some of the functionalities of the wireless device according to any one of the embodiments of FIGS. 2 to 7. Accordingly, the at least one processor, the memory, and the computer program code form processing means for carrying out embodiments of the present invention in the wireless device. According to yet another embodiment, the apparatus carrying out the embodiments of the invention in the wireless device comprises a circuitry including at least one processor and at least one memory 20 including computer program code 22. When activated, the circuitry causes the apparatus to perform the at least some of the functionalities of the wireless device according to any one of the embodiments of FIGS. 2 to 7.

As used in this application, the term ‘circuitry’ refers to all of the following: (a) hardware-only circuit implementations, such as implementations in only analogue and/or digital circuitry, and (b) to combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) to circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular element, a baseband integrated circuit or applications processor integrated circuit for a wireless device.

The processes or methods described in connection with FIGS. 2 to 7 may also be carried out in the form of a computer process defined by a computer program. The computer program may be in source code form, object code form, or in some intermediate form, and it may be stored in a transitory or a non-transitory carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units.

The present invention is applicable to wireless networks defined above but also to other suitable wireless communication systems. The protocols used, the specifications of wireless networks, their network elements and terminals, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1.-35. (canceled)

36. A method comprising:
performing, by a wireless device by using a first radio interface of the wireless device, an association to an access node of a wireless network;
indicating, by the wireless device to the associated access node, transition to a dormant mode and entering the dormant mode where the first radio interface is disabled;
receiving, by the wireless device in the dormant mode, a wake-up frame from the access node through a second radio interface of the wireless device;
upon receiving the wake-up frame, maintaining the dormant mode towards the access node but temporarily enabling, by the wireless device, the first radio interface to receive at least one frame from the access node;
receiving said at least one frame by the wireless device through the first radio interface and, upon receiving said at least one frame, disabling the first radio interface in the dormant mode.

37. The method of claim 36, wherein the wireless device switches, upon receiving the wake-up frame, from a doze state of the dormant mode to an active state of the dormant mode, and wherein the wireless device switches, upon receiving said at least one frame, from the active state of the dormant mode to the doze state of the dormant mode.

38. The method of claim 37, wherein the wireless device further enables the first radio interface in the dormant mode and switches to the active state upon maintaining the doze state for a determined time interval.

39. The method of claim 37, wherein the wireless device further enables the first radio interface in the dormant mode and switches to the active state upon determining to transmit a frame to the access node.

40. The method of claim 36, wherein the first radio interface is disabled in the dormant mode at least for a duration longer than a beacon transmission interval of the access node.

41. The method of claim 36, wherein the wireless device further switches, according to a determined criterion, from the dormant mode to a power management mode where the first radio interface is enabled and the second radio interface is disabled.

42. The method of claim 41, wherein the power management mode is a power-save mode or an active mode according to IEEE 802.11 specifications.

43. An apparatus for a wireless device, the apparatus comprising:
at least one processor; and at least one memory including a computer program code, wherein the at least one memory and the computer program code are configured, with the at least one processor, to cause the apparatus to:
perform, by using a first radio interface of the wireless device, an association to an access node of a wireless network;
indicate, to the associated access node, transition to a dormant mode and enter the dormant mode where the first radio interface is disabled;
receive, in the dormant mode, a wake-up frame from the access node through a second radio interface of the wireless device;
upon receiving the wake-up frame, maintain the dormant mode towards the access node but temporarily enable the first radio interface to receive at least one frame from the access node;
receive said at least one frame through the first radio interface and, upon receiving said at least one frame, disable the first radio interface in the dormant mode.

44. The apparatus of claim 43, wherein the at least one memory and the computer program code are configured, with the at least one processor, to cause the apparatus to switch, upon receiving the wake-up frame, from a doze state of the dormant mode to an active state of the dormant mode, and to switch, upon receiving said at least one frame, from the active state of the dormant mode to the doze state of the dormant mode.

45. The apparatus of claim 44, wherein the at least one memory and the computer program code are configured, with the at least one processor, to cause the apparatus to enable the first radio interface in the dormant mode and to switch to the active state upon maintaining the doze state for a determined time interval.

46. The apparatus of claim 44, wherein the at least one memory and the computer program code are configured, with the at least one processor, to cause the apparatus to enable the first radio interface in the dormant mode and switch to the active state upon determining to transmit a frame to the access node.

47. The apparatus of claim 43, wherein the at least one memory and the computer program code are configured, with the at least one processor, to cause the apparatus to disable the first radio interface in the dormant mode at least for a duration longer than a beacon transmission interval of the access node.

48. The apparatus of claim 43, wherein the at least one memory and the computer program code are configured, with the at least one processor, to cause the apparatus to switch, according to a determined criterion, from the dormant mode to a power management mode where the first radio interface is enabled and the second radio interface is disabled.

49. The apparatus of claim 48, wherein the power management mode is a power-save mode or an active mode according to IEEE 802.11 specifications.

50. The apparatus of claim 48, wherein the at least one memory and the computer program code are configured, with the at least one processor, to cause the apparatus to transmit, when switching from the dormant mode to the power management mode, an uplink frame to the access node, wherein the uplink frame comprises an information element indicating said switching from the dormant mode to the power management mode.

51. The apparatus of claim 43, wherein the first radio interface employs a first radio access technology and the second radio interface employs a second radio access technology different from the first radio access technology.

52. An apparatus for an access node of a wireless network, the apparatus comprising at least one processor; and at least one memory including a computer program code, wherein the at least one memory and the computer program code are configured, with the at least one processor, to cause the apparatus to:
perform, by using a first radio interface of the access node, an association to a wireless device;
receive, from the associated wireless device, an indication that the wireless device shall transition to a dormant mode where the wireless device cannot be contacted by the access node by using the first radio interface;
determine to transmit at least one frame to the wireless device and, upon said determining, use a second interface of the access node to transmit a wake-up frame to the wireless device;
after transmitting said wake-up frame, maintain information that the wireless device is in the dormant mode and use the first radio interface to transmit the at least one frame to the wireless device.

53. The apparatus of claim 52, wherein the at least one memory and the computer program code are configured, with the at least one processor, to cause the apparatus to perform, upon completing the transmission of the at least one frame to the wireless device, the next communication with the wireless device through the second radio interface unless the access node receives an explicit indication that the wireless device has transitioned from the dormant mode.

54. The apparatus of claim 52, wherein the at least one memory and the computer program code are configured, with the at least one processor, to cause the apparatus to receive, from the wireless device, a frame comprising an information element indicating that the wireless device has switched from the dormant mode to a power management mode where the wireless device can be reached through the first radio interface but not through the second radio interface.

55. The apparatus of claim 52, wherein the first radio interface employs a first radio access technology and the second radio interface employs a second radio access technology different from the first radio access technology.
